(19) United States
(12) Patent Application Publication
(10) Pub. No.: US 2008/0288287 A1
(43) Pub. Date: Nov. 20, 2008

(54) Saferite system

(76) Inventor: Sydney D. Stanners, Sidney (CA)

Correspondence Address: DIEDERIKS & WHITELAW, PLC, 12471 Dillingham Square, #301, Woodbridge, VA, 22192, US

(21) Appl. No.: 12/149,441

(22) Filed: May 1, 2008

Related U.S. Application Data
(63) Continuation-in-part of application No. 10/092,571, filed on Mar. 8, 2002, now abandoned.
(60) Provisional application No. 60/274,206, filed on Mar. 9, 2001.

(51) Int. Cl. G06Q 50/00; G06Q 10/00

(52) U.S. Cl. 705/2

(57) ABSTRACT

A system for allowing a user, such as a physician, to prepare a prescription form in multiple parts: one part encoding the prescription information (such as through a bar code, radio frequency identification, or other encoding means), and a second part containing a graphic or physical representation of the medication being prescribed. The encoded part is used by a pharmacist to compare the coded information on the prescription with coded information on the medication selected by the pharmacist to confirm if the codes match. The graphic representation portion is used by a patient to double-check that the medication provided by the pharmacy matches the physician's prescription.

### CROSS REFERENCE TO RELATED APPLICATIONS

This application claims the benefit of priority as a continuation in part of U.S. patent application Ser. No. 10/092,571, filed Mar. 8, 2002, which claims the benefit of priority of U.S. Provisional Patent Application Serial No. 60/274,206, filed Mar. 9, 2001, which is incorporated herein by reference in its entirety.

### FIELD OF THE INVENTION

The present invention relates generally to systems and methods for safely and effectively prescribing and dispensing medication.

### BACKGROUND OF THE INVENTION

It has been suggested that medical errors are a leading cause of death and injury in North America. Many of these medical errors relate to prescription medication or prescription mix-ups, such as the patient receiving the wrong medication, the wrong dosage of the right medication, incompatible medications or the wrong frequency of medication. Some of these errors are attributed to physician's illegible handwriting, and others to medication selection and dispensing errors in the pharmacy. Other errors result when medication is administered to the wrong patient in the hospital.

More specifically, medication or drug errors can be divided into two main categories:

1.Category 1: prescription writing errors. The following errors may occur at the time the prescription is written: (a) wrong medication—the selected medication is inappropriate for the patient's medical condition, (b) strength—the correct medication but wrong strength, (c) instructions—the correct medication but wrong dosage instructions, (d) abbreviation—the incorrect use of an abbreviation, (e) interaction—the prescribed medication will interact with other current prescriptions, (f) contraindication—medication not compatible with the patient's medical condition, (g) allergy—the patient is allergic to the medication, (h) patient's name—the wrong patient name is written (sometimes the name of the previous patient), (i) verbal orders—orders given by telephone are a continuing source of errors ,(j) handwriting—the physicians handwriting is illegible or difficult to read; and

2. Category 2: pharmacy dispensing errors. The following errors may occur at the time that the pharmacist fills the prescription: (a) handwriting—illegible or difficult to read handwritten prescriptions lead to many dispensing errors, (b) verbal orders—orders received by telephone are often misunderstood, (c) medication selection—the wrong medication is selected (d) look alike selection errors—occur when medication names look alike, (e) sound alike selection errors occur because medication names sound alike, (f) strength—the wrong medication strength is selected, (g) instructions incorrect patient instructions, (h) interaction—the dispensed medication will interact with (other) current prescription's, (i) contraindication—medication not compatible with patients medical condition, j) allergy—the patient is allergic to the medication (k) patient chart—various entry errors and chart mix-ups (l), communication—the prescription is given out to the wrong patient, (m) DIN number medication—DIN number is confused with look alike DIN number.

In addition to the same prescribing and dispensing errors highlighted above, further medication errors occur in the hospital when patient identities are confused, resulting in medication mix-ups (that is, the patient is given someone else's medication).

In response to the issue of illegible handwriting by physicians, some products are coming to market that print a prescription. Generally speaking, these prescriptions are “written” in the physician's office and entail the use of a portable digital assistant or handheld computer, computer, and office printer.

Although these technologies create a legible prescription in either hard copy or electronic format, they lack design components that prevent pharmacy selection errors. Additionally, they do not allow the patient to determine whether or not the dispensed medication matches their prescription.

In order to prevent medication errors, a system should include a three-part action plan (“3 Part Action Plan”) to: (i) prevent errors that originate with the physician/writer; (ii) prevent pharmacy dispensing errors; and (iii) involve the patient. Failure to address any one of these parts of the 3 Part Action Plan may result in ongoing and unabated medication errors such as that occurring in the prior art.

An examination of the PDA/prescription products (see FIG. 11) has found all are uniform in their design approach. Each prescription met the criteria of part one of the 3 Part Action Plan—that is, the prescriptions were checked and printed in the physician's office (or sent to the pharmacy electronically)—but lacked the design features necessary to provide other stakeholders in the prescription loop (the pharmacist, nurse and patient) a comprehensive prescription safety platform. Other than providing a legible (printed) prescription to the pharmacist, other products did not meet the other two criteria of the 3 Part Action Plan and, therefore, do not reduce or prevent errors occurring in these areas.

One such prior art system is a hospital system designed to deliver dispensed medication to patients in a ward, but lacks the capabilities of the present system to prevent medication or mix-ups in the hospital pharmacy. Therefore, such prior art system cannot guarantee the correct medication will reach the patient.

Other prior art systems focus on reducing errors associated with the physician's handwriting and may include systems to optically scan such handwriting to convert a handwritten prescription into an electronic prescription. While such systems address the first part of the 3 Part Action Plan, they fail to address the remaining parts. For example, such systems fail to include any verification by the pharmacy that the medication it has prepared matches the prescription.

### SUMMARY OF THE INVENTION

Other aspects and features of the present invention will become apparent to those ordinarily skilled in the art upon review of the following description of specific embodiments of the invention in conjunction with the accompanying figures.

The present system provides a state of the art, user friendly, low cost solution to the widespread problem of medication mix-ups (the term medication referring to drugs or medicine). The system creates an error free prescription to progress seamlessly from the physician through the pharmacy to the patient. The system's design addresses each of the criteria outlined in the 3 Part Action Plan.

The system generally includes two sub-systems:
1. a printing system used by a physician to prepare a two part prescription to print or electronically transmit to a pharmacy. If the prescription is printed it will contain a code such as a bar corresponding to the prescribed medication and if sent electronically will be similarly coded; and
2. a reader which is a code reading and comparison device used by the pharmacy receiving the prescription to prevent medication or mix-ups in the pharmacy by reading and comparing codes on the physician-prepared prescription and the codes on the medication prepared by the pharmacy (such as the codes found on medication containers which correspond to the medication) to identify any discrepancies.

The use of the printing system fully integrated with the use of the reader, resulting in a highly efficient, error prevention system.

The printing system allows a physician to quickly and accurately prepare and print (or electronically transmit) a prescription. By using a printed prescription format, the system precludes errors associated with illegible handwriting.

The printing system prints a code (such as a bar code hologram) representing the drug's name and strength on the prescription. In cases where the prescription is electronically transmitted to a pharmacy, it can be printed by the pharmacy or accessed by the reader for the purposes of verification of the prescription and prescribed medication by the pharmacist.

The patient checklist portion of a prescription encourages patient participation in the prescription loop by providing the patient with an easy-to-follow sequenced checklist.

Safety features incorporated into the prescription are available at each step of the prescription loop.

The reader's innovative design enables a pharmacist to quickly carry out a code comparison check of a prescription and a medication selected from the pharmacist's stock. This step helps prevent pharmacy selection errors.

In addition to the printing system and the reader, a hospital system includes a bedside visual display that enables a nurse to ensure that the prescribed medication goes to the correct patient.

The efficiencies provided to physicians by the system will discourage giving verbal prescription orders by telephone.

The system provides end users with a powerful safety technology. Benefits accruing to the end user and health care system include substantial financial savings, the reduction of deaths and injuries to patients, and the professional satisfaction of providing the patient a risk free (medication) environment.

Some of the benefits and other elements of the system include the following:
1. a printed prescription prevents pharmacy errors caused by poor handwriting and reduces time consuming calls from pharmacists to physicians; some physicians report saving 1-2 hours daily when using similar products;
2. results in a complete check of the prescription data by a pharmacist and by a patient;
3. flags allergies;
4. checks health plan formulary for medication or drug authorization;
5. the prescription can be printed in the physician's office or electronically sent to the pharmacy (or both);
6. the prescription data can be transferred to a patient's electronic record;
7. the system speeds up the refill process, as prescription data from a patient's electronic record is instantly available; and
8. drug or medication safety notices can be flagged by the physician and transferred to the system to ensure that the system is continually up-to-date.

### BRIEF DESCRIPTION OF THE DRAWINGS

Embodiments of the present invention will now be described, by way of example only, with reference to the attached Figures, wherein:

FIG. 1 illustrates a two section prescription prepared by the printing system in accordance with an embodiment of the present system;

FIG. 2 is a schematic showing the sequence of prescription preparation and 3 Part Action Plan in accordance with an embodiment of the present system;

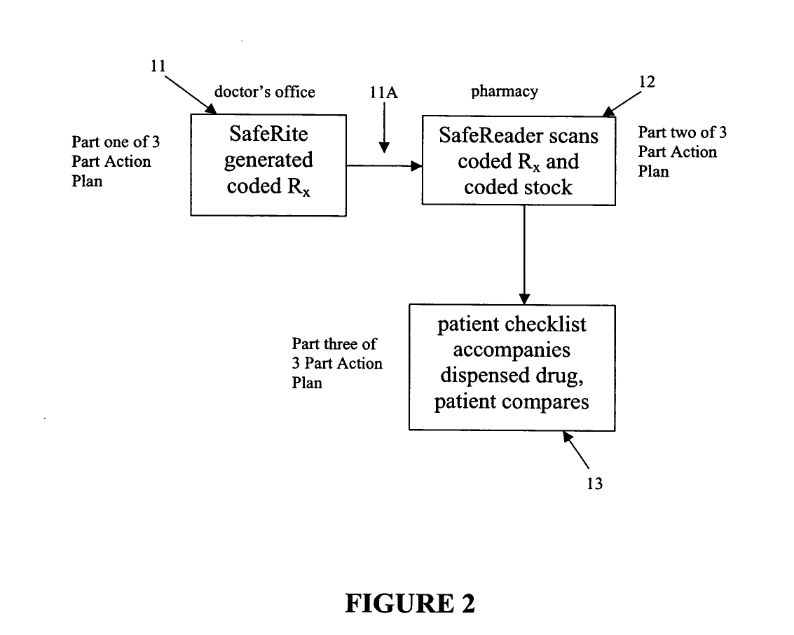

FIG. 3 illustrates a printing system-generated prescription in which a generic substitution has been made for a brand name medication in accordance with an embodiment of the present system;

FIG. 4 illustrates a generic label see for attachment to a prescription in accordance with an embodiment of the present system;

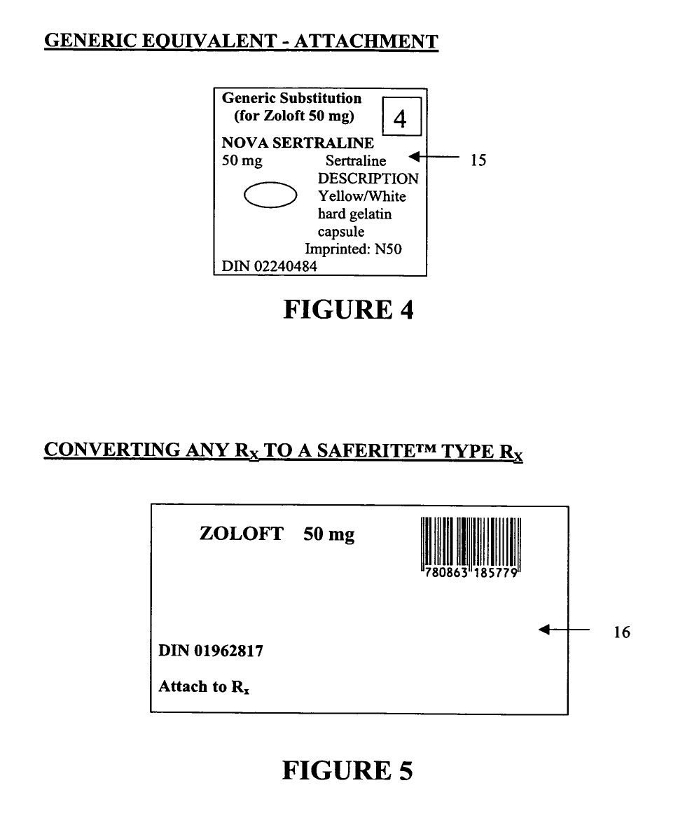

FIG. 5 illustrates a bar coded label for attachment to any prescription that is not prepared by a printing system in accordance with an embodiment of the present system;

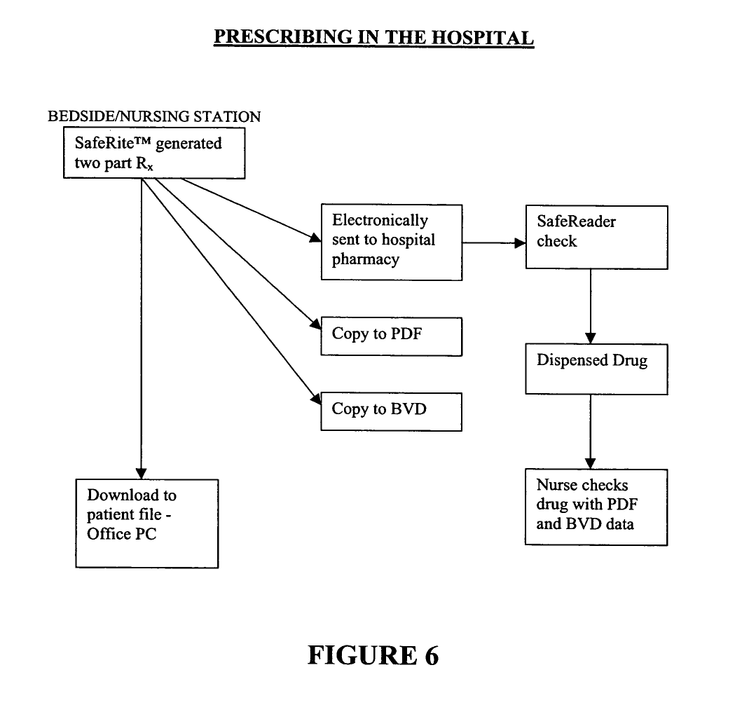

FIG. 6 is a schematic of the printing system and reader sequence of use in hospital and clinical settings in accordance with an embodiment of the present system;

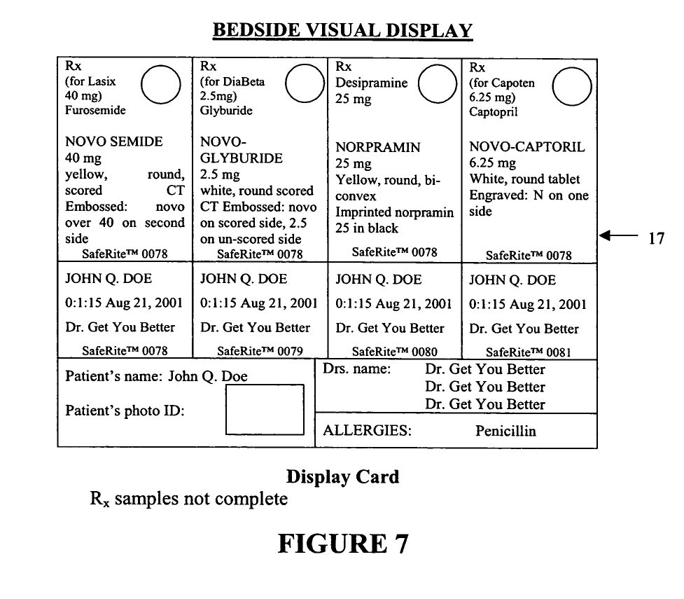

FIG. 7 illustrates a bedside visual display for hospital and clinical use in accordance with an embodiment of the present system; and

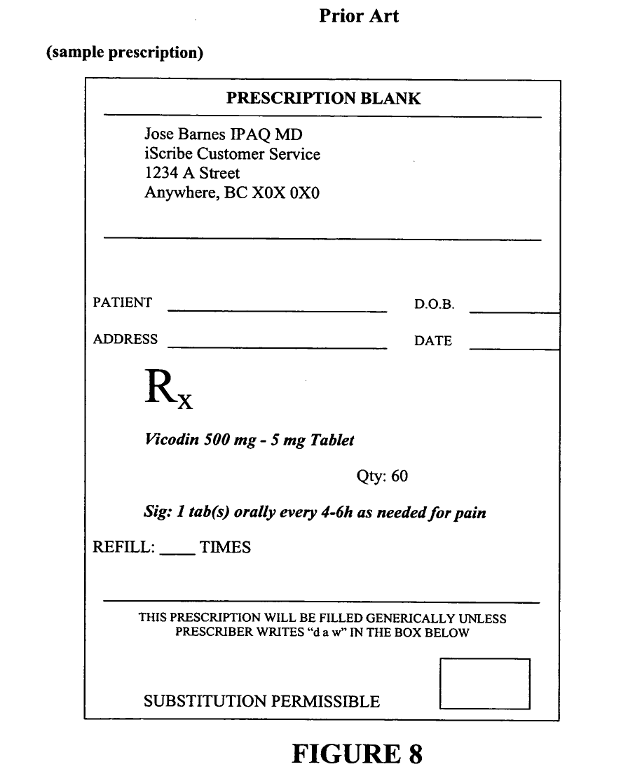

FIGS. 8 and 9 show prescription samples of prior art computer generated prescription products in accordance with an embodiment of the present system.

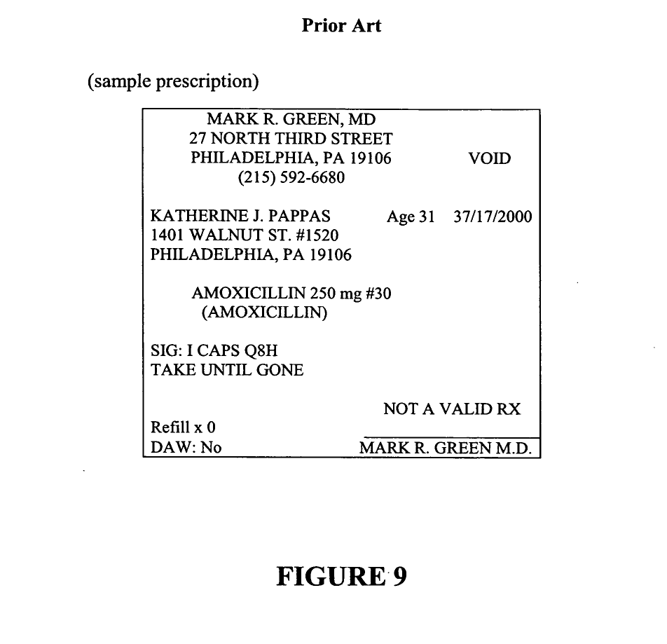

### DETAILED DESCRIPTION

### Prescription Design

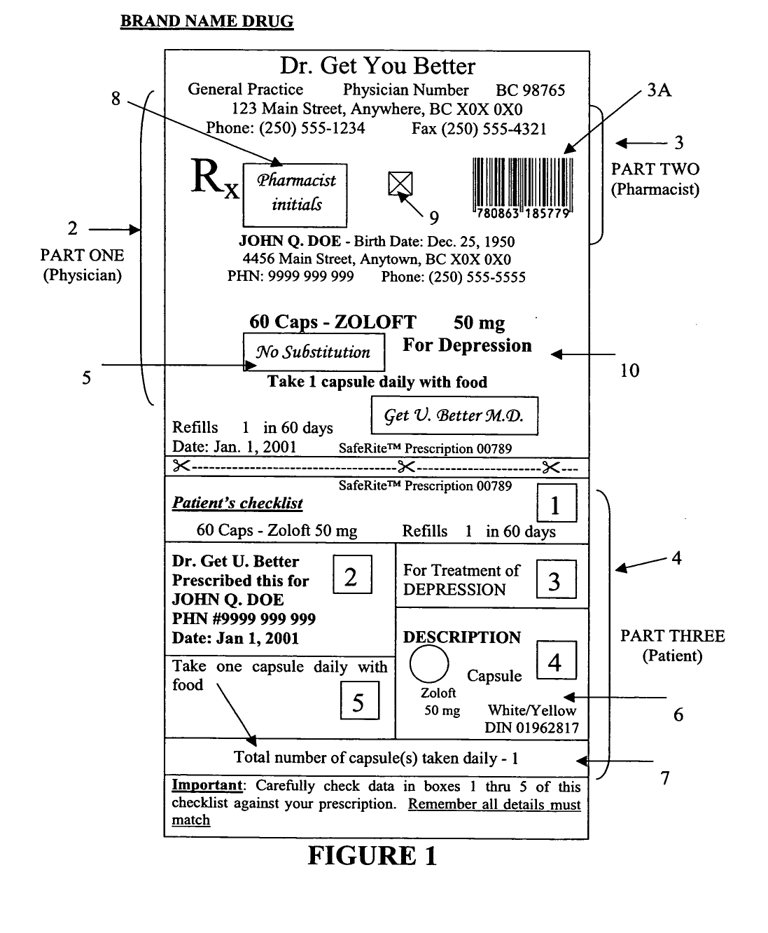

A prescription generated by the printing system produces a computer generated (printed or electronically transmitted) prescription as shown in FIG. 1, includes built-in safety features and content, specifically the physician's part 2, the pharmacy's part 3 and the patient checklist 4, involves a patient in a final cross-check of the dispensed medication through the use of the patient checklist 4, and provides a user-friendly design requiring minimum prescription input.

One skilled in the art will appreciate that the prescription prepared by the printing system will adhere to characteristics of good design and optimal functionality and, as such, may include features such as clear, large, easy to read printed prescription, a flexible format such as allowing print and/or electronic transmission, and conformance with the 3 Part Action Plan.

To prevent generic substitution, a physician may write the appropriate “No Substitution” or “Dispense as Written” etc. in the box 5 provided.

Prescription instructions such as “take 1 tablet daily with meals” can be thoroughly confusing to some patients. It is not clear if this means the patient should take 1 tablet each day or take 1 tablet with each meal. To remedy this common misunderstanding, an information block 7 is added to the bottom of the patient's checklist 4 on the prescription prepared by the printing system.

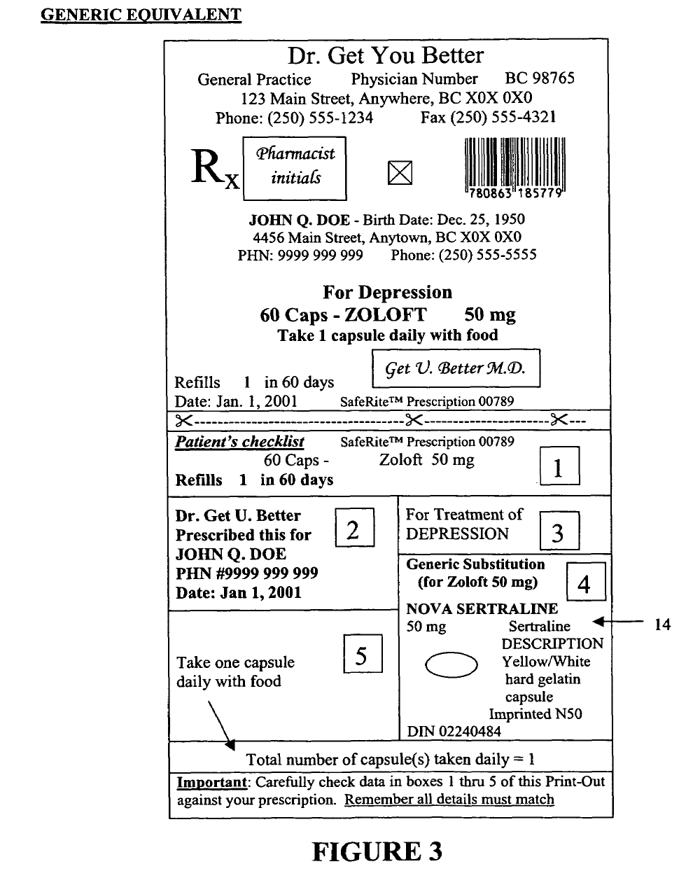

For example, the prescription for Zoloft—take 1 capsule daily with meals—would read “take one capsule with food” and indicate the total number of daily capsules as shown in FIGS. 1 and 3.

The form of prescription prepared by the printing system eliminates the need for the pharmacy to call physician regarding missing prescription data and, since the reason for treatment 10 is prominently displayed on prescription, a pharmacist can determine if the prescribed medication matches the patient's medical condition. The physician may otherwise ordinarily omit this information if not using the printing system.

The patient checklist 4 prepared by the printing system leads the patient through the easy to follow patient medication verification steps. This may help further reduce medication errors. For example, if a pharmaceutical company accidentally printed bar codes on its medication packages and mislabeled medication, then a pharmacy may provide a patient with the wrong medication, but a visual scan by the patient, as directed by the patient checklist, may identify the error.

### In the Physician's Office

The printing system (referenced as “Saferite” in the figures) includes any form of printer capable of preparing a written or encoded prescription or electronically transmitting a prepared prescription. One skilled in the art will appreciate that physicians may prepare prescriptions using a combination of a portable digital assistant, computer and printer or any computing device.

In operation, the physician retrieves a patient's name and medical or health record from a PC or PDA or other computing device. The physician enters the reason for treatment (such as depression) using the computing device and is given a menu of appropriate medications (possibly from a pre-defined formulary), then electronically prepares the prescription by selecting a medication, dosage, quantity, and by entering patient instructions.

The computing device checks that the selected medication is correct for the patient's medical condition, contraindications, for medication interactions with other current prescriptions and for correct patient instructions. Any allergies are flagged. The patient's health plan formulary for medication approval may also be checked.

A code representing the medication's brand name and strength any other relevant details about the medication (such as available or desired generic substitutes) is added to the prescription. One skilled in the art will appreciate that any coding means such as a bar code, hologram, RFID tag or other can be used for coding the prescription.

The physician then reviews the prescription, prints and signs.

If the prescription is being sent by computer or by fax or other transmitting device not requiring printing, then the signature is computer generated or the prescription is otherwise electronically signed. The prescription may also be printed.

The physician may then transmit the prescription directly to the pharmacy such as via the Internet or over a secured line. The transmitted data is encrypted or otherwise protected to comply with patient data confidentiality issues. The physician is able to transmit, or fax a prescription to a pharmacy from remote locations.

To facilitate refills, the physician may call up the applicable patient's health record.

### In the Pharmacy

The reader (also referred to as “SafeReader” in the drawings) reads and compares the prescription code and the code on a medication's stock container (such as the bar code corresponding to the medication found within the container). The reader includes a printer for printing illustrated generic substitution data 14.

The reader ensures that the medication or drug taken from the pharmacy's stock matches the prescription in both selection and strength by comparing prescription's code (shown as bar code 3A) with a code displayed on the pharmacist's medication stock container.

The reader accepts generic substitutes for brand name medication and transfers the brand name or generic name, as well as scanned stock container's code, to a pharmacy working copy and to a patient prescription file. Such code may be translated prior to printing it on the pharmacy working copy or on the patient prescription file.

A simple, effective, low cost method of preventing “look alike/sound alike” medication errors and other selection errors while filling the prescription in the pharmacy, is by incorporating a code—containing the drug's brand name and strength—into the pharmacist's print out portion of the prescription. The prescription code should duplicate the medication's brand name and strength contained in the code appearing on the medication's stock container (such as bar code).

To determine if the medication taken from the pharmacist's stock matches the prescription, the pharmacist scans the codes appearing on the prescription and the medication's stock container. An incorrect selection of the medication or medication strength is immediately flagged. One skilled in the art will appreciate that the current system may allow other forms of comparison (such as prescription bar code to radio frequency ID tag on the medication container or bin from the pharmacy's stock or hologram prescription code to hologram code on the medication container taken from stock).

Scanning may be accomplished by using a handheld scanner or a dedicated scanning or other code reading unit. The unit may scan both codes more or less simultaneously or individually. The unit accepts matching codes, but rejects or flags non-matching codes. The pharmacist rectifies an error by selecting the correct medication from stock. Matching codes allow the system sequence to continue.

Brand name medication selection: to determine if the medication taken from stock matches the prescription, the pharmacist scans both the prescription code and the medication code with the reader. The reader performs a dual code scan comparing medication name(s) and strength(s). Non matching data is immediately flagged. The reader prints a validation mark 9 on the prescription once the codes match and the pharmacist places his/her initials in the box 8 provided. The reader then transfers the medication's code to the pharmacy working copy and to the patient prescription file to facilitate refills. The brand name medication's code acts as a master code and matches all generic substitute codes.

Generic medication selection: the code from the generic medication's container from the pharmacy's stock is read by the reader and compared against the prescription's code which is similarly read by the reader. The reader then transfers the generic medication's code to the pharmacy working copy and the patient's prescription file. The reader prints a new description containing the generic medication's data and illustration onto an adhesive generic substitution label 15, which the pharmacist places over the original description 6 on the patient checklist. The codes of allowable generic substitutions to a given brand name are not interchangeable. Only the originally dispensed generic medication's code will subsequently be accepted by the reader, thereby preventing mix-ups of allowable generic medication when refilling a prescription.

In one embodiment, the system accesses pharmaceutical companies offering no cost/low cost medication to patients encountering financial hardship which may be factored into the medication ultimately selected by the pharmacist for a patient if substitutions are permitted.

On refills, the medication's code from the patients' prescription file is transferred to the pharmacy working copy or may be available on the pharmacy working copy if printed on the pharmacy working copy when the prescription was initially filled. The code on the pharmacy working copy is then compared by the reader to the code on the medication selected by the pharmacist from stock to determine if the selection matches the prescribed medication.

The coded working copy is read by the reader in the same manner as the original prescription and compared against the coded medication container from stock to prevent refill mix-ups.

At the time the generics' code is transferred to the pharmacy working copy and to the patient prescription file, the brand name's code as provided on the prescription is automatically invalidated by the reader, thereby isolating the generics' code for future scanning checks. Likewise, when a brand name medication is to be filled and its code data transferred from the prescription to the pharmacy working copy and patient prescription file, the allowable generic substitution information contained in the brand name's master code is invalidated by the reader. Therefore, only the reader, assuring correct medication selection, recognizes the code belonging to the brand name medication.

In another embodiment, an additional code (such as a bar code) containing patient ID may be added to the prescription by the printing system. When the additional code is read by the reader, it opens up the pharmacy patient prescription file, preventing patient chart mix-ups and prescription/patient entry errors. This feature facilitates further safety checks. Other codes are added as necessary or as desired.

In another embodiment, the reader can convert any prescription provided by a physician into a prescription compatible with use as part of the system. To accomplish this, the pharmacist enters the prescription medication name and strength into the pharmacy computer (or directly into the reader) which converts the data into a code (such as a bar code) which is printed together with the medication's name and strength on an adhesive generic substitution label 16 which is affixed to the prescription. The newly coded prescription and code on the medication container are subsequently read and compared by the reader to assure correct medication and strength selection. The reader then prints an abbreviated, illustrated patient checklist which accompanies the dispensed medication or drug.

Pharmacists who receive a prescription generated by a printing system who do not have a reader will benefit from the printing system's prescription and patient check-list.

While the primary function of the reader is to provide a comparison of the codes appearing on the prescription and on the medication stock container, the reader may also include or be connected to a printer for preparing a pharmacy working copy, generic substitution labels 15, 16 as required and any other portion of the final prescription as indicated. One skilled in the art will recognize that the reader may also be connected to or include a computing device for storing or transmitting the codes scanned, for storing or transmitting evidence of a successful match or a corrected match, etc.

When dispensing the medication, the pharmacist separates the patient checklist 4 from the rest of the prescription. The patient checklist 4 is attached to the dispensed medication.

The pharmacist, together with the patient, then goes through the patient checklist.

### The Patient Checklist

The patient is the ultimate beneficiary of the system. Each feature of the system is designed to help prevent patient injury and death caused by medication errors. In doing so, the system confers many benefits to the other stakeholders in the prescription loop including physicians, pharmacists and nurses.

A patient checklist 4 accompanies a dispensed prescription. On receiving the dispensed medication, the patient alone, or together with the pharmacist, follows the patient checklist to compare the patient checklist data with the information printed on the medication or drug vial/container.

The patient with or without the pharmacist's assistance visually checks that the dispensed medication, matches the graphic representation 6 in box four of the patient checklist 4. The graphic representation, in a preferred embodiment, is life-size.

This last step of the 3 Part Action Plan, which takes only a few moments, can be critical to the success of the error prevention program and, at the same time, conforms to pharmacy professional patient counseling requirements if the pharmacist reviews the patient checklist 4 with the patient.

FIG. 1 describes the general workflow of the system as described above. In particular, a coded prescription is prepared (11), the coded prescription is provided or transmitted (11A) to a pharmacy, the prescription's code is compared (12) against previously coded medication stock selected by the pharmacy to determine if there are any discrepancies and, after the medication is dispensed to the patient (or during the dispensing by the pharmacy), the patient checks (13) the patient checklist on the prescription (including a graphic representation of the prescribed medication) against the instructions provided on the dispensed medication and visually against the dispensed medication itself to check for any errors.

### In the Hospital and Hospital Pharmacy

In an alternative embodiment, the system may be used within a hospital setting. The hospital system requirements are much the same as those for the physician and the pharmacy.

A hospital doctor or attending physician who makes rounds uses the printing system to select and print a prescription. The prescription may be printed at a patient's bedside by using a handheld printer, at a nurse's station or elsewhere. A copy of the patient checklist 4 (hospital version) is placed in a bedside visual display 17 for viewing by nurses, physicians and the patient.

A second copy of the prescription and patient checklist are placed in a patient record at the nurses' station. When a generic substitution of the prescribed medication has taken place, the nurse attaches copies of the illustrated generic substitution data 14 (box four of the patient checklist) to the bedside visual display 17 and patient record. Generic attachments are printed once only and accompany the medication the first time it is dispensed to the patient.

The doctor transmits or provides the prescription to the hospital pharmacy. Prescription data may be subsequently downloaded to patient's file or record. The patient record allows a check of the prescription received at a nursing station to the medication ultimately dispensed by the hospital pharmacy.

The bedside visual display 17 provides a nurse with illustrated prescription information to serve as another means of ensuring that the correct medication is dispensed.

In one embodiment, patient data, such as condition/illness etc., is contained on the reverse side of the card printed for the bedside visual display 17. In order to accommodate additional prescriptions, additional display cards may be hung beneath the original card in the bedside visual display 17. One card will contain recent medication history.

In the hospital pharmacy, the pharmacist uses a reader to read the prescription code, read the code on the medication container in stock and compare the codes to ensure they describe the same medication and strength selection. Any of the other functions performed by the reader by the pharmacist described above may also apply in the hospital pharmacy setting, noting that additional information or materials may be prepaid using the reader for the patient record or for the bedside visual display 17. The hospital pharmacist may use a reader to convert a prescription not prepared by a printing system to a coded prescription as described in more detail above.

When the dispensed medication prepared by the hospital pharmacy is received at a nursing station, a nurse may update the patient record or bedside visual display 17 (or both) as required, depending on the material generated by the reader and depending on whether generic or brand name medication was dispensed.

When administering the prescription to the patient in a ward, the nurse checks that the dispensed medication matches the graphic representation 6 included in the patient checklist displayed in the bedside visual display 17.

By using the bedside visual display 17, medication administering protocol, which takes only a few moments, the nurse is assured that the right medication is given to the right patient, and that the medication and medication strength complies with the written prescription order.

Routing information (for example, Fl.5 Rm.123 Bd. C) may be displayed on the patient checklist 4 and accompany the prescribed medication. The physician may add routing data at the time the prescription is written.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

What is claimed is:

1. A system for prescribing and dispensing medication to a patient comprising:
a. a printing system for allowing a physician to prepare a prescription in multiple parts, one part containing a code representing the prescription information and a second part containing a graphic representation of the medication being prescribed; and
b. a reader for use by a pharmacy to compare the code on the prescription to a code on medication prepared by the pharmacy for allowing the pharmacy to identify any discrepancies between the two codes to identify potential prescribing errors.

2. A system as in claim 1, wherein the printing system can cross reference the prescription information with the patient's health record to identify contraindications or interactions with other current patient prescriptions.

3. A system as in claim 1, wherein the printing system can cross reference the prescription information with a formulary for the patient for medication approval.

4. A system as in claim 1, wherein the prescription includes the prescribed medication's name and strength.

5. A system as in claim 1, wherein the printing system is a personal digital assistant in communication with a printer.

6. A system as in claim 1, wherein the printing system can cross reference the prescription information with the patient's health record to identify any patient allergies.

7. A system as in claim 1, wherein the reader permits a match between a prescription code for a brand name medication and a code for pharmacy-prepared medication for a generic name medication which corresponds to the brand name medication.

8. A system as in claim 7, wherein the code for the generic name medication is added to the patient's record to prevent mix-ups on refills.

9. A system as in claim 8, wherein the code for the generic name medication will not match a code for another generic name medication, even if both generic name medications are substitutes for the same brand name medication, to help prevent mix-ups on refills.

10. A system as in claim 1, wherein the prescription contains a second code which corresponds to patient identification for allowing the pharmacy to review the patient's record for consistency as a further safeguard against chart mix-ups and patient data entry errors.

11. A system as in claim 1, wherein the prescription further includes a patient checklist which describes the prescription's proper use for comparison against the instructions provided on the medication dispensed by the pharmacy.

12. A system as in claim 1, wherein the graphic representation of the medication being prescribed is detached from the prescription form for placement beside the patient's hospital bed in a bedside visual display for allowing a nurse to visually compare any provided medication for the patient against the graphic representation in the bedside visual display.

13. A system as in claim 12, wherein the patient checklist is placed in the bedside visual display.

14. A system for prescribing and dispensing medication to a patient comprising:
a. a printing system for allowing a physician to prepare a prescription containing a code coinciding with the prescription information along with a graphic representation of the medication being prescribed;
b. means for electronically transmitting the prescription form to a pharmacy;
c. a printer for the pharmacy to print the prescription containing the code; and
d. a reader for use by the pharmacy to read and compare the code on the prescription to the code on the medication prepared by the pharmacy for allowing the pharmacy to identify any discrepancies between the two codes.

15. A system as in claim 14, wherein the prescription information is encoded prior to sending it electronically to the pharmacy.

16. A method for prescribing and dispensing medication for a patient comprising:
a. providing a prescribing physician with a device for accepting and storing prescription information for the patient and the patient's reason for treatment to allow the physician to print a prescription containing at least one code representing the prescription information along with a graphic representation of the medication being prescribed for placement beside a patient's hospital bed in a bedside visual display for allowing a nurse to visually compare any medication for the patient against the bedside visual display;
b. providing the prescription to a pharmacy;
c. preparing medication matching the description on the prescription; and
d. comparing the code on the prescription with the code on the medication for identifying any discrepancies.

17. A method as in claim 16, wherein the patient visually checks the medication provided to the patient by the pharmacy against the prescription form's graphic representation of the medication.

18. A method for reducing prescribed medication errors for a patient comprising:
a. selecting medication from a list available for prescribing therapeutic treatment to a patient;
b. selecting a patient's record from a list available;
c. checking for suitability of the prescribed medication for the patient based on the details of the patient's record;
d. printing a code representing the medication name and strength;
e. printing a patient checklist including an illustration of the medication to add to the prescription; and
f. comparing the code against a second code on the medication prepared by a pharmacy for flagging any non-matching information.

19. A method as in claim 18 including the additional step of comparing the patient checklist against the instructions provided with the medication dispensed by the pharmacy to determine if the medication dispensed to the patient matches the medication prescribed for the therapeutic treatment of the patient.

20. A system for prescribing and dispensing medication for a patient comprising:
a. a printing system for preparing a prescription including at least one code corresponding to medication; and
b. a reader for comparing the at least one code on the prescription with at least one code on the medication prepared by a pharmacy corresponding to such medication for confirming that the codes on the prescription and medication match.

21. A system for a pharmacy to verify that medication prepared by the pharmacy matches the medication prescribed by a physician comprising a code reading and comparison device for reading a code on the prescription corresponding to the physician-prescribed medication, reading a code on the medication prepared by the pharmacy and comparing the codes to determine if they match.

22. A method for a pharmacy to verify that medication prepared by the pharmacy matches the medication prescribed by a physician comprising reading a code on the prescription corresponding to the physician-prescribed medication, preparing medication for the patient, reading a code on the medication prepared by the pharmacy and comparing the codes to determine if they match.

23. A system for a pharmacy to verify that medication prepared by the pharmacy matches the medication prescribed by a physician comprising a device for reading the details of the prescription, printing a revised prescription including a code corresponding to the medication prescribed by the physician, reading the code on the revised prescription, reading a code on the medication prepared by the pharmacy and comparing the codes to determine if they match.

24. A method for a pharmacy to confirm that the medication it prepares corresponds to medication prescribed by a physician in a prescription comprising the steps of:
a. preparing a revised prescription which includes a code corresponding to the physician-prescribed medication;
b. preparing medication for the patient; and
c. comparing the code on the revised prescription with a code on the medication to determine that they match.

25. A system for a pharmacy to dispense generic medication to a patient when brand name medication was prescribed by a physician on a prescription, comprising:
a. a reader for reading a code on the prescription corresponding to the brand name medication;
b. a device for comparing the brand name medication to a list of suitable generic medications;
c. a printer for printing a pharmacy working copy of the prescription containing a code corresponding to the generic medication and for printing an adhesive label with a graphic representation of the generic medication for attachment to the prescription; and
d. a second device for comparing the code on the pharmacy working copy to the code on the generic medication prepared by the pharmacy to determine if they match.

26. A system as in claim 25, wherein the device and the second device are the same device.

27. A system for a pharmacy to refill a prescription for a patient comprising:
a. a device for preparing a pharmacy working copy of a prescription when the prescription is initially filled by the pharmacy, the pharmacy working copy including a code corresponding to medication set out in the prescription; and
b. the device for reading the code on the pharmacy working copy, reading a code on refill medication prepared by the pharmacy for dispensing to the patient and comparing the codes on the pharmacy working copy and medication to determine if they match.
